(19) United States
(12) Patent Application Publication
(10) Pub. No.: US 2023/0153054 A1
(43) Pub. Date: May 18, 2023

(54) AUDIO PROCESSING IN A SOCIAL MESSAGING PLATFORM

(71) Applicant: Twitter, Inc., San Francisco, CA (US)

(72) Inventors: Raina Plom, San Francisco, CA (US); Reed Martin, San Francisco, CA (US)

(21) Appl. No.: 17/968,363

(22) Filed: Oct. 18, 2022

Related U.S. Application Data
(60) Provisional application No. 63/279,021, filed on Nov. 12, 2021.

(51) Int. Cl. G06F 3/16; H04L 51/52; H04L 51/10; G10L 15/26

(52) U.S. Cl. CPC G06F 3/165; G10L 15/26; H04L 51/10; H04L 51/52

(57) ABSTRACT

Methods, systems, and apparatus, including computer programs encoded on a computer storage medium that receive, from a first client that has joined an audio conversation space of a social messaging platform, user interface presentation data that represents one or more audio tones of background audio for the audio conversation space. Background audio data representing the one or more audio tones of background audio for the audio conversation space can be generated from the user interface presentation. Conversation audio data can be received from one or more clients. A mixed audio stream can be generated and can include the conversation audio data received from the one or more clients and one or more other audio signals generated from the background audio data representing the background audio for the audio conversation space. The mixed audio stream can be presented to other client devices that have joined the audio conversation space.

### CROSS-REFERENCE TO RELATED APPLICATIONS

This application claims the benefit under 35 U.S.C. § 119(e) of the filing date of U.S. Pat. Application No. 63/279,021, entitled “AUDIO PROCESSING IN A SOCIAL MESSAGING PLATFORM,” which was filed on Nov. 12, 2021, and which is incorporated here by reference.

### BACKGROUND

This specification relates to social messaging platforms, and in particular, to providing background music in audio conversation spaces on social messaging platforms.

Social messaging platforms and network-connected personal computing devices allow users to create and share content across multiple devices in real-time. Sophisticated mobile computing devices such as smartphones and tablets make it easy and convenient for people, companies, and other entities to use social messaging platforms and applications. Popular social messaging platforms generally provide functionality for users to have audio conversations and chats with other users of the platform.

An audio conversation space is a dynamic, audio-oriented social media venue that can be created by one member of the social messaging platform, the “host,” and joined by other users of the platform. Users can participate in the audio conversation space by speaking in the audio conversation space, listening to the conversation in the audio conversation space, or submitting other, non-audio content, such as text, social messaging posts, emoji, or stickers, to the audio conversation space.

### SUMMARY

In general, innovative aspects of the subject matter described in this specification relate to generating a mixed audio stream from input received from client devices that have joined an audio conversation space of a social messaging platform and efficiently providing that mixed audio stream to the client devices over a network. Users of client devices can provide the input through interactions with a specialized user interface created by client software of the social messaging platform.

An audio conversation space is an interface that is hosted on a social media platform for users of the platform to participate in an audio-based conversation. Audio conversation spaces usually remain open for participation for a limited amount of time.

Particular embodiments of the subject matter described in this specification can be implemented so as to realize one or more of the following advantages. The techniques described below can be used to generate, efficiently encode and distribute background music for an audio conversation space, reducing bandwidth requirements and improving the scalability of conversation spaces and the overall system. Further, the techniques described below can allow the collaborative development of background music for an audio conversation space. Further, the techniques described below can be used to aggregate tones from multiple participants participating in an audio conversation space, optionally applying quantization to improve the quality of the background music.

One aspect features receiving, from a first client on a first user device that has joined an audio conversation space of a social messaging platform, user interface presentation data that represents one or more audio tones of background audio for the audio conversation space. Background audio data representing the one or more audio tones of background audio for the audio conversation space can be generated from the user interface presentation. Conversation audio data can be received from one or more clients. A mixed audio stream can be generated and can include the conversation audio data received from the one or more clients and one or more other audio signals generated from the background audio data representing the background audio for the audio conversation space. The mixed audio stream can be presented to one or more other client devices that have joined the audio conversation space.

One or more of the following features can be included. The background audio data can be generated from the user interface presentation data by the client device. The background audio data can be data generated from the user interface presentation data by the social messaging platform. The conversation audio data can be data generated from one or more microphones of the first user device while the background audio data is be not generated from one or more microphones of the first user device. The background audio data can include encoded musical notes. Generating a mixed audio stream can include quantizing the audio data in time, pitch, or both. Receiving the user interface presentation data can include receiving user interface presentation data generated by a touch sensitive display, and each of a plurality of regions of the touch sensitive display can correspond to different audio tones. Based at least in part on the user interface presentation data, at least one attribute of at least one of the one or more audio tones to be included in the mixed audio stream can be determined, and audio data that includes at least one audio tone with the at least one attribute can be generated. Determining at least one attribute can include: (i) determining coordinates associated with the user interface presentation data; (ii) determining, based at least in part on the coordinates, at least one value for the at least one attribute; and (iii) generating, audio data that includes at least one audio tone containing the at least one attribute of the at least one value. Generating the mixed audio stream can include continually looping the background audio data representing the one or more audio tones with newly received audio signals from other client devices. User interface presentation data of the second user device can be received from a second client on a second user device that has joined the audio conversation space. Space data corresponding to the user interface presentation data received at the second user device can be generated. The space data can be transmitted to at least one client that has joined the audio conversation space. A first location of a first user input and a second location of a second user input can be determined; a duration between the first user input and the second user input can be determined; using the first location, the second location and the duration, a rate of change between the first location and the second location can be determined; and the background audio data can be generated, at least in part, using the rate of change. Generating background audio data can include translating at least one of the one or more audio tones to a textual representations. The textual representation can be a letter. A first tone of the one or more audio tones can be mapped to a first fragment of audio data, and a second tone of the one or more audio tones can be mapped to a second fragment of audio data. From at least the first fragment of audio data and the second fragment of audio data, an audio file can be generated.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example social messaging platform for providing background music to users of an audio conversation space using a social messaging platform.

FIG. 2 is a flow diagram of an example social messaging platform for providing music in a social messaging platform.

FIGS. 3A, 3B, 4A, 4B, 5A, and 5B are illustrations of user interface presentation data generated by a social messaging platform for providing music in a social messaging platform.

FIG. 6 is a flow diagram illustrating a process of adjusting tones in response to user input. Like reference numbers and designations in the various drawings indicate like elements.

### DETAILED DESCRIPTION

Audio conversation spaces provide a convenient venue for audio-focused social interaction among users of a social messaging platform. Audio conversation spaces enable users to quickly and easily join and participate in audio interactions. For example, the platform can automatically provide invitations to join an active audio conversation space to users of the platform who are followers of the user hosting the audio conversation space. Similarly, invitations to join an active audio conversation space can be automatically provided to followers of each user who has joined the audio conversation space as a speaker. Followers of the host and speakers in an audio conversation space can be automatically alerted when the audio conversation space is initiated and can easily join and participate in the conversation.

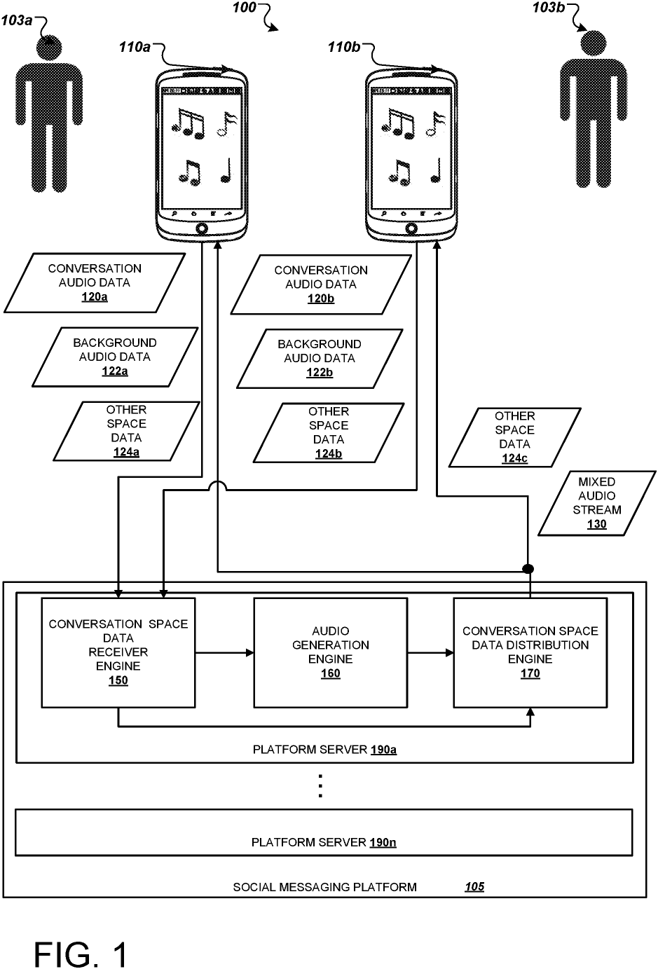

FIG. 1 is a diagram of an example system 100 for providing background music to users of an audio conversation space who are using a social messaging platform. The system 100 can include a social messaging platform 105 that can receive data, including conversation audio data 120a, 120b, background audio data 122a, 122b, and other space data, from one or more user devices 110a, 110b, each associated with a respective user 103a, 103b.

Each client device 110a, 110b can be any appropriate computing device, e.g., a mobile phone, a tablet computer, a laptop computer, a desktop computer and so on, running client software configured to provide a user interface for a user to interact with and obtain services provided by the platform. A client device can include a variety of input mechanisms, e.g., a touch screen, keyboard, pen-style input, voice, mouse, and so on.

The client software on each client device 110a, 110b can generate data, including conversation audio data 120a, 120b, background audio data 122a, 122b, and other space data 124a, 124b, that represents data relevant to audio conversations spaces, e.g., spoken language data, posts, emojis, likes, images, videos, and links.

The conversation audio data 120a-b is data that is picked up by a microphone at the client device. The conversation audio data thus typically includes audio of a user’s voice and can also include other sounds picked up by the microphone, e.g., police sirens, thunderstorms, and dogs barking. The conversation audio data 120a-b can be represented using a variety of audio formats appropriate for encoding audio data. For example, the conversation audio data can represented in encoded formats including WAV, MP3, M4A, FLAC, AAC, and WMA.

In contrast to the conversation audio data 120a-b, the background audio data 122a-b can be generated by the client devices 110a-b not through a microphone, but by user input on a user interface of the client devices. For example, the client devices 110a, 110b can generate the background audio data 122a as a set of commands or musical tones.

The encoded background music can then be interpreted by other devices so as to efficiently provide background music for presentation in audio conversation spaces. For example, the client devices 110 can encode the background audio data as one or more commands associated with the user interactions received by a client devices 110a-b. Alternatively or in addition, the client devices 110 can encode the background audio data 122a-b as one or more musical tones that can be interpreted as commands for another device to produce the corresponding tones as background audio in the audio conversation spaces. In this specification, a tone refers to any appropriate distinctly identifiable sound that can be reproduced at a client device. Tones thus include musical sounds, vocal sounds, or any other appropriate type of sound of any appropriate duration. By representing audio data as a set of commands or musical tones instead of in a raw or encoded audio format, the client devices 1 10a-b can communicate and process background music in audio conversation spaces in a more space-efficient format, which can result in lower network bandwidth requirements and greater responsiveness.

The client devices 110 can also share other data besides conversation audio and background music in conversation spaces, referred to in this specification as other space data 124a-b. The other space data 124a-c can be represented in a variety of formats. For example, the other space data can include data encoded as a text representation, e.g., as XML governed by a schema appropriate for space data. The format can include outer tags, e.g., <SpaceData> ... </SpaceData>, and inner tags appropriate for each type of space data, e.g., <Post> [Post] </Post>, <Link> [Link] </Link>, and <Image> [encoded image data] </image>. One space data element can contain multiple pieces of space data. For example, one instance of other space data 124a-c can include a post and an indication of a like for another post. While the data format can be text-based, some components of the other space data 124a-c, e.g., spoken language, images and video, can be encoded in a non-text format, e.g., as a binary encoding.

The client devices 110a-b can transmit and receive conversation audio data 120a-b, background audio data 122a-b, and other space data 124a-c over a network, e.g., the Internet. Client devices can connect to the network through a mobile network, through a service provider, e.g., an Internet service provider (ISP) or otherwise. Client devices can transmit and receive data using any suitable protocol, e.g., HTTP and TCP/IP. Client devices can separately transmit audio data 120a-b and other space data 122a-b or can transmit a combined stream of audio data and other space data 124a, 124b.

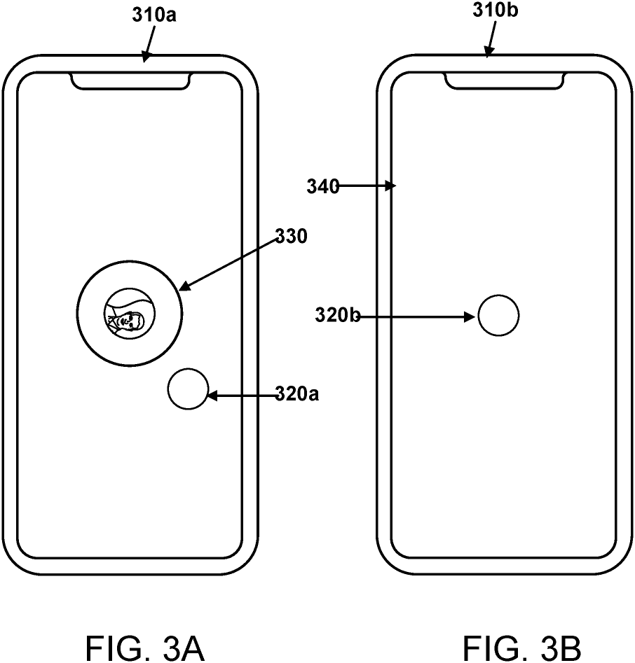

A client device 110a, 110b can also display a specialized user interface generated by the social messaging platform 105 for a user to input commands for background music. User interface presentation data can include representations of any aspect of a user interface, including displayable and hidden user interface objects, actions, properties, etc. For example, user interface presentation data can include a description of user interface widgets to be rendered on a client device 110a, 110b. User interface presentation data can also include descriptions of actions performed on the user interface, e.g., swipes, clicks, long presses, etc., and properties of the actions, such as their location, duration, time of occurrence, among many other examples. User interface presentation data can also include information determined from interactions with a user interface, such as tones derived from user interactions with user interface presentation data, as described further below. The user interface presentation is described in more detail with reference to FIGS. 3-6.

The social messaging platform 105 can be implemented on one or more servers 190a-190n in one or more locations. Each server can be implemented on one or more computers, e.g., on a cluster of computers. Each server can be connected to a network, e.g., the Internet, and the servers can connect to the network through a mobile network, through a service providers, e.g., an Internet service provider (ISP), through a direct connection to the network, or otherwise. Each server can transmit and receive data over the network. Servers can transmit and receive data using any suitable protocol, e.g., HTTP and TCP/IP.

The social messaging platform 105 can include a conversation space data receiver engine 150, an audio generation engine 160, and a conversation space data distribution engine 170 The social messaging platform 105 can provide a mixed audio stream 130 and other space data 122c to one or more of the client devices 110a, 110b. The mixed audio stream 130 can include a mix of audio from one or more instances of conversation audio data 120a-b, audio from one or more instances of background audio data 122a-b, or some combination of these. For example, the mixed audio stream 130 can include audio data picked up from microphones of two client devices as well as audio generated from background audio data input by one of the client devices.

The conversation space data receiver engine 150 can receive data, including audio data 120a, 120b, background audio data, and other space data 122a, 122b, transmitted from one or more client devices over the network. The conversation space data receiver engine 150 can provide the conversation audio data 120a, 120b and background audio data to an audio generation engine 160. The space data receiver engine 150 can provide other space data 124-b to the space data distribution engine 170.

The audio generation engine 160 can receive one or more instances of conversation audio data 120a, background audio data 120b, or both, and create the mixed audio stream 130.

The conversation space data distribution engine 170 can provide the mixed audio stream 130, and other space data 122c, to one or more client devices 110a, 110b.

The conversation space data distribution engine 170 can provide the mixed audio stream 130 in a number of different ways. For example, the conversation space data distribution engine 170 can (i) create an individual connection to each client device 110a, 110b and transmit the mixed audio stream 130 using a protocol such as TCP/IP; (ii) distribute the mixed audio stream 130 to multiple client devices 110a-b simultaneously using a multicast protocol such as IP multicast; (iii) distribute the mixed audio stream 130 to multiple client devices 110a-b simultaneously using a broadcast protocol, for example, using a protocol such as IETF RFC 919; or (iv) use other content delivery techniques.

In addition, the conversation space data distribution engine 170 can provide user interface presentation data for display on client devices as described in reference to FIGS. 3-6.

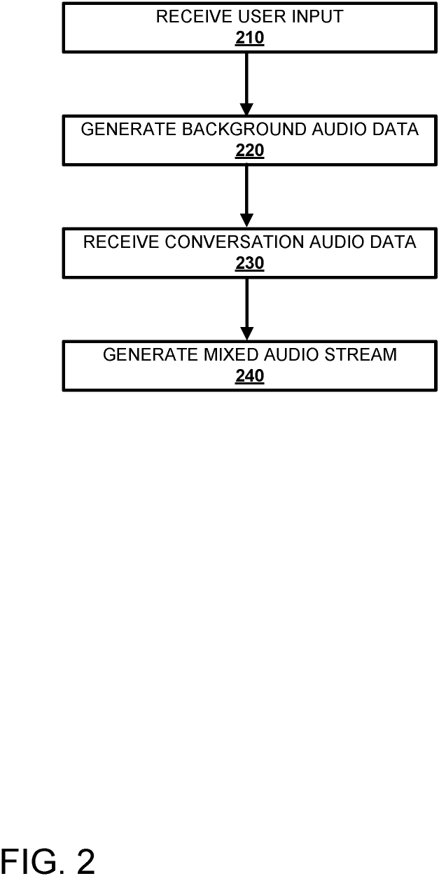

FIG. 2 is a flow diagram of an example process for efficiently allowing users to provide background audio in an audio conversation space. For convenience, the process will be described as being performed by a system that includes client devices interacting with a social messaging platform, e.g., the social messaging platform 105 of FIG. 1.

The system receives (210), from a first client device, user interface presentation data that represents audio tones of background audio for an audio conversation space (210). In some implementations, the user interface presentation data is received by the first client device, and in some implementations, the user interface presentation data is received by the social media platform. As described above, an audio tone can refer to any musical, vocal or other type of sound of any duration. To allow for the receipt of user input, the first client device can display a user interface rendered from user interface presentation data that is included as part of client software provided by a social messaging platform and/or user interface presentation data downloaded to an application such as a web browser on the first client device.

The system can receive multiple types of user input. The input can represent background audio tones to be used in a mixed audio stream of an audio conversation space. A user can submit the input by interacting with the user interface presentation data as described further in reference to FIGS. 3-6. Users can also input other data relevant to an audio conversation space, e.g., spoken words, photos, videos, links, social media posts, likes, and so on.

The user can provide user input to the client device using any of a number of user interaction technologies, e.g.: (i) touchscreen gestures including tapping, swiping, long-pressing, two-finger gestures, and so on; (ii) pen input including writing, tapping, swiping and so on; (iii) voice input; (iv) keyboard input; (v) mouse input; (vi) eye movement; or (vii) a combination of the technologies listed.

In some implementations, the user interface presentation data can allow the user to select one or more musical instruments, e.g., guitar, piano, synthesizer, drums, or flute, and the user input can then represent background audio tones produced by those instruments. In addition, the user interface can allow the user to alter the tones created by the specified musical instrument, for example, by indicating that the volume should be higher or lower, the beat should be faster or slower or the pitch should be higher or lower. Some aspects of this implementation of the display of user interface presentation data are described further in reference to FIGS. 3-6.

In some implementations, the user interface accepts input representing a set of audio tones. For example, the tones can be pitches represented by the letters A through G, and when the user input corresponds to a sequence of tones F-G-F, the system can represent the user input data using corresponding letters, that is, {F, G, F}. Optionally, the user input can include indications of accidentals such as sharp and flat, and the accidentals can be encoded in the user input data. For example, sharp can be encoded as “#” and flat “b”, so F-sharp can be encoded in the audio data as {F#}. In some implementations, the user interface is rendered on a touch sensitive display and regions of the touch sensitive display correspond to different audio tones. When a user selects a region, for example, by tapping, the user input represents the audio tone associated with the region.

In some implementations, the user interface includes a palette of tones, e.g., “soft synthesizer;” a range of volume options, e.g., “loud,” “medium” and “quiet”; and a range of pitch options, e.g., “A” to “G”. The user input can include an indication of the selections chosen by the user, e.g., {“Soft synthesizer”, “quiet”, “F”}.

In some implementations, the user interface accepts data representing a number of repetitions or a duration of repetition. For example, the user input data can indicate that the music represented by the user input should repeat 10 times, until 2 minutes elapses, or until stopped.

In some implementations, the social messaging platform provides different user interfaces to different client devices. For example, one client device might receive user interface presentation data reflecting tones associated with guitar sounds while a second client device might receive user interface presentation data reflecting tones associated with piano sounds. In such cases, the user input data can reflect the instrument associated with the user interface presentation data. The system generates, from user interface presentation data, background audio data representing one or more audio tones of background audio for an audio conversation space (220).

The specific generation techniques depend on the format of the input received from the user and the format of the audio data. In implementations where the user input is a set of tones, the audio data can encode a representation of the tones. In implementations that support the selection of instruments, the user input can include an indication of one or more instruments that the user intends to have render the tones. For example, the audio data can include {“Piano”, {F, G,F}}.

In some implementations, the social messaging platform can generate an audio file to represent the background audio data, e.g., an MP3 file. For example, the social messaging platform can include, for each supported instrument or sound palette, a mapping of tones to a corresponding fragment of audio data. The social messaging platform can map each portion of the user input data into a corresponding fragment of background audio, then assemble the fragments of background audio into an audio file. The social messaging platform can compute the encoding for the tone using conventional encoding technologies appropriate for the audio format.

In implementations where the user interface presentation data includes a duration, or in implementations where there is a configured default duration, the audio data can include an indication of that duration. In implementations where the social messaging platform generates an audio file, the social messaging platform can continue the process of generating the file until the play length of the audio file matches the duration.

In an alternate implementation, a client device can generate the background audio data. In such implementation, the client device rather than, or in addition to, the social media platform can perform the operations described above. For example, in implementations where the user input is a set of tones, the client device can create audio data can encode a representation of the tones and can generate an audio file to represent the background audio data. The client device can transmit the background audio data to the social media platform.

The system receives conversation audio data (230). As described above, the conversation audio data is audio data that is received by one or more microphones at a user device or another device communicatively coupled to the user device. For example, the conversation audio data can record the user’s voice while participating in a verbal dialogue in the audio conversation space. Meanwhile, the background audio data need not be captured by microphones, but is instead captured by the user interface described below.

The system generates a mixed audio stream that includes the conversation audio data and the background audio data (240). The mixed audio stream can be generated by a social messaging platform or by another user device that is participating in the audio conversation space. For example, a social messaging platform can generate a mixed audio stream from the background audio data and the conversation audio data and then provide the mixed audio stream to one or more user devices. Alternatively, the social messaging platform can provide the conversation audio data and the background audio data to one or more other user devices that will generate and present a corresponding mixed audio stream. A client device that has joined the audio conversation space can then present the mixed audio stream having both background audio generated by user input and conversation audio picked up by one or more microphones.

Providing both the conversation audio data and the background audio data to the client devices generally does not significantly increase the network bandwidth required for the audio conversation space because of the way that the background audio data can be represented using a particular encoding, e.g., text representing notes. Providing the background audio data separately can provide for additional flexibility in generating the background audio because the background audio data can include additional encoded information about how the background audio should be generated. For example, the background audio data can include an encoded sequence of notes as well as a duration indicator and a repeat indicator to represent how long the sequence should last and how many times the sequence should be repeated when the background audio is rendered.

The techniques used to create the mixed audio stream will depend on the format of the audio data and the format of the mixed audio stream. For example, if the background audio data represents a set of tones to be included in the mixed audio stream, the system can combine the tones with the conversation audio data using any appropriate audio mixing techniques to create a mixed audio stream that includes the tones from one or more instances of audio data.

Optionally, to improve the perceived quality of the audio, the system can quantize the mixed audio stream in time or in pitch. For example, the system can quantize the mixed audio stream in time using a technique e.g., time stretching, to change the speed or duration of an audio signal without affecting its pitch. In another example, the system can quantize the pitch in the mixed audio stream using any appropriate pitch correction technologies, e.g., using a harmonizer, which is a type of pitch shifter that combines a pitch-shifted signal with the original to create a two or more note harmony.

In some implementations, the user interface presentation data used to input background audio data includes only user-selectable options that result in audio data suitable for combination with other audio data. In such cases, the resulting mixed audio stream might not require further quantization.

If the background audio data includes a duration indicator, the client device can play the tones of the background audio data until the duration indicator is satisfied. For example, if the duration indication states “5 minutes,” the client device can play the tones as the background audio 5 minute has elapsed.

If the mixed audio stream contains encoded data, the client device translates the encoded data into tones. For example, if the encoded representation of mixed audio data indicates a series of pitches at a given volume produced by an instrument, the client device renders the corresponding tones using conventional techniques such as those used by software instrument simulators.

FIGS. 3A and 3B are illustrations of user interface presentation data presented on a client device.

In FIG. 3A, a client device 310a displays user interface presentation data that was generated by a social messaging platform such as the social messaging platform of FIG. 1. The user interface presentation data can include a graphic object 330, e.g., an image which can be associated with initial music. The graphic object 330 can be selectable by a user to change operational modes. For example, single tapping on the graphic object 330 might cause the system to enter music-editing mode while double tapping might cause the system to enter volume-adjustment mode. A cursor 320a is included in the figure to illustrate a position that can be selected by a user, e.g., by tapping.

Optionally, the user interface presentation data can indicate that presentation of the graphic object 330 should be dynamic. For example, the user interface presentation data can indicate that the image 330 should be rendered as spinning around a central axis in a manner similar to a record playing, pulsating with the beat of the music, bouncing or following other dynamic patterns.

In FIG. 3B, a client device 310b displays user interface presentation data represents a background pattern 340 instead of an image 330. A cursor 320b is again included to illustrate a position that can be selected by a user.

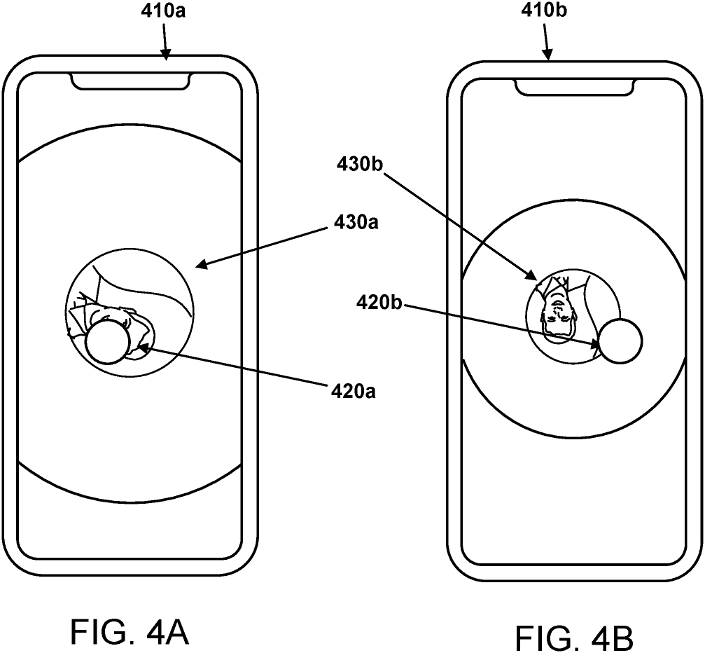

FIGS. 4A and 4B are illustrations of user interface presentation data generated by a social messaging platform for providing music in a social messaging platform, and more specifically user interface presentation data that can represent attributes of the music, e.g., volume and beat.

In FIG. 4A, a client device 410a displays user interface presentation data displayed on a client device. A cursor 420a is in an initial position, and an image 430a is of an initial size representing an initial state for an attribute of the music, e.g. an initial volume or an initial beat.

In FIG. 4B, the client device 420a displays user interface presentation data that was generated by a social messaging platform. A cursor 420b has been moved by a user to the right indicating that the user wishes to change an attribute of the music, e.g., increasing its volume. The user interface presentation data indicates that the image 430b should be rendered as a larger size representing the updated attribute of the music, e.g., an increased volume or a faster beat. The client device 420a can encode the attribute changes and transmit them to an social messaging platform; the social messaging platform can adjust the mixed audio data to reflect the altered attribute; and the social messaging platform can distribute the adjusted mixed audio data to the client devices participating in the audio conversation space, as described in reference to FIG. 2.

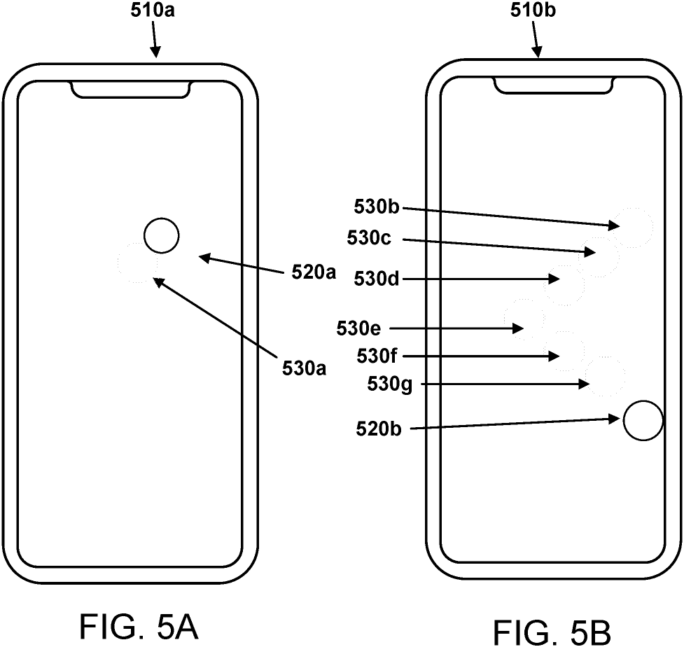

FIGS. 5A and 5B are illustrations of user interface presentation data displayed on a client device, and more specifically user interface presentation data that allows a user to add instruments or additional instances of an existing instrument.

In FIG. 5A, a client device 510a displays user interface presentation data that was generated by a space data processing platform. In this illustration, through interactions with user interface presentation data generated by an social messaging platform, a user has first indicated, for example, by entering a long-press on the client device 5 10a, to the social messaging platform that social messaging platform should enter music editing mode, then the user has provided, for example, by entering a short-press in a region 510a of the client device interface, a visual indication 530a of a request to alter the music being generated by the social messaging platform. The indication can reflect, for example, a request to add a first instrument (e.g., a piano) to produce tones. The illustration also includes a cursor 520a shown after the user has left the visual indication.

In FIG. 5B, the client device 520b again displays user interface presentation data. In this illustration, through an interaction with user interface presentation data, a user has left, in regions of the client device interface, a set of visual indications 530a-d of requests to alter the music being generated by the social messaging platform. Each indication can reflect, for example, a request to include an additional instrument, e.g., drums, a flute, or a synthesizer, or an additional instance of an instrument, e.g., additional pianos, already producing tones.

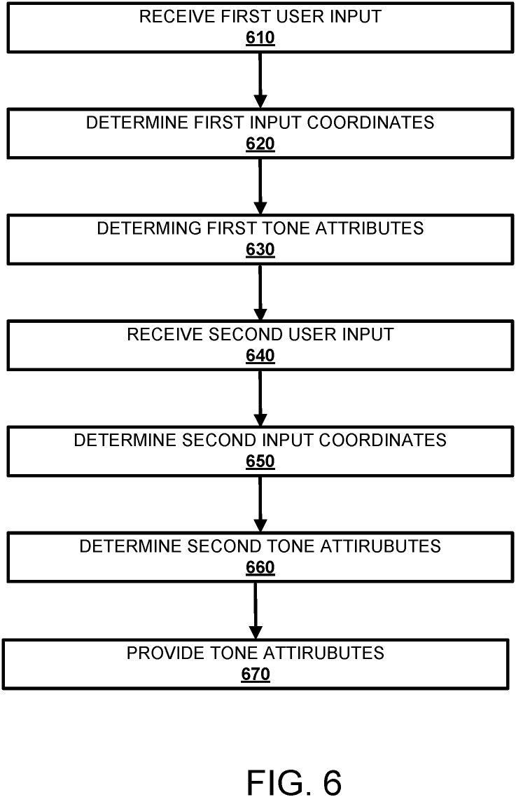

The position of an indication can be used to provide information about the request. In response to a user interacting with the user interface generated from the user interface presentation data, for example, by entering a short press, the social messaging platform can receive the coordinates of the interaction. The social messaging platform can then translate the coordinates into attributes of a tone. For example, indications that are higher on the screen - i.e., they have larger Y-coordinates - might indicate a request for an increase in one attribute, and indications that are farther right - i.e., they have larger X-coordinates - might indicate a request for an increase in another attribute. Conversely, indications that are lower on the screen - i.e., they have smaller Y-coordinates - might indicate a request for a decrease in one attribute, and indications that are farther left - i.e., they have smaller X-coordinates - might indicate a request for a decrease in another attribute. This process is explained in more detail with reference to FIG. 6.

FIG. 6 is a flow diagram illustrating a process of adjusting tones in response to user input. For convenience, the process will be described as being performed by client devices interacting with a social messaging platform, e.g., the social messaging platform 105 of FIG. 1.

The system accept a first user input (610). A user can provide the user input by a user interacting with user interface presentation data displayed on a client device. The first user input can indicate that the user selected a location in a region on the client device, for example, by tapping or clicking on the location.

The system determines the coordinates of the user input (620). The system can use conventional operations to determine the coordinates. For example, the system can call an Application Programming Interface (API) provided by the operating system on the user device that is configured to provide coordinates of the selected location. In some implementations, the system can receive event data generated by an operating system in response to a user interaction with the client device, and that event data can include the coordinates.

The system determines first tone attributes (630). Attributes can include any property of a tone, e.g., volume, pitch or beat. In one example, an indication in the upper right of a screen indicates a request for higher pitch and a more rapid beat. In some implementations, the social messaging platform can allow the user to interact with user interface presentation data to configure which axis corresponds to which attribute. For example, by interacting with user interface presentation data, the user might indicate that the X axis corresponds to pitch and the Y axis corresponds to beat.

The system can determine the value for the attribute by translating the value of each coordinate to a value for the attribute. The system can apply a configured function associated with an attribute to the coordinate value, and each attribute can have a different configured function. For example, if the Y axis corresponds to beat, the system might divide the selected Y coordinate by 100 to determine the number of beats per second. Analogous steps can be performed for the X axis.

The system accept a second user input (640). As described with reference to operation 610, a user can provide the user input by a user interacting with user interface presentation data displayed on a client device.

The system determines the coordinates of the second user input (650). As described with reference to operation 620, the system can use conventional operations to determine the coordinates. The system can further determine the duration of time between the first user input and the second user input by comparing the times at which the first user input and the second user input were accepted.

The system determines second tone attributes (660). In some implementations, the system determines second tone attributes by applying a configured function to the coordinates determined in operation 650, as described with reference to operation 630.

In some implementations, the configured function can operate on any combination of coordinates, the rate of change of the coordinates, and the current value of an attribute. That is, New Attribute = F(Coordinates, Rate of Coordinate Change, Current Attribute ) for some configured function F. For example, if the user performed a “swipe” motion, the system can determine, from data provided by the operating system on the client device relating to the swipe, the velocity of the swipe. The velocity can then be used in the configured function. For example, a higher velocity can be associated with a greater rate of change for the attribute.

The system provides the tone attributes (670), for example, by transmitting the tone attributes to an audio component on the client device.

As shown in FIG. 5B, optionally, after receiving the tone attributes and making a corresponding adjustment to the tones, the social messaging platform can quantize the mixed audio stream in time or in pitch to improve the quality of the audio, as described in reference to FIG. 2.

A cursor 520b is also illustrated, and if the user taps at that position, an additional indication would be created and processed, as described above,

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Background music can enliven an audio conversation space by setting a mood or a tone, and by eliminating “dead air” when no user is currently speaking. By providing capabilities that enable users of the audio conversation space to collaboratively develop the background music, a social messaging platform can increase the engagement of its users. In addition, providing the ability for users to collaboratively develop the background music, for example, one person supplying guitar tones, another piano tones and a third drum tones, can increase engagement and user satisfaction.

However, adding music encoded using conventional codecs, such as MPEG Audio Layer III (MP3), Advanced Audio Coding (AAC) and Waveform Audio File Format (WAV) codecs, creates additional demand on network bandwidth. Additionally, with collaboratively developed music, the codecs impose additional demand as both contributions from users to the collaboratively developed music and the resulting mixed audio must be transmitted over the network. Increasing the demand on many types of network can slow the delivery of other traffic, and increased demands can create a prohibitive burden on bandwidth-constrained networks.

In addition, not all users possess talent in music composition, so simply mixing raw input from all participants could create a musically undesirable result. In addition, even if all users possess talent, if the raw inputs are developed independently, the mixed result could similarly be musically undesirable. Further, many users are unfamiliar with musical instruments, so it is desirable to provide a specialized user interface that does not require musical knowledge.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:
Embodiment 1 is a method comprising:
   receiving, from a first client on a first user device that has joined an audio conversation space of a social messaging platform, user interface presentation data that represents one or more audio tones of background audio for the audio conversation space;
   generating, from the user interface presentation, data background audio data representing the one or more audio tones of background audio for the audio conversation space;
   receiving, from one or more clients, conversation audio data;
   generating a mixed audio stream comprising the conversation audio data received from the one or more clients and one or more other audio signals generated from the background audio data representing the background audio for the audio conversation space; and
   presenting the mixed audio stream to one or more other client devices that have joined the audio conversation space.

Embodiment 2 is the method of embodiment 1, wherein the background audio data is generated from the user interface presentation data by the client device.

Embodiment 3 is the method any one of embodiments 1-2, wherein the background audio data is generated from the user interface presentation data by the social messaging platform.

Embodiment 4 is the method any one of embodiments 1-3, wherein the conversation audio data is data generated from one or more microphones of the first user device and the background audio data is not generated from one or more microphones of the first user device.

Embodiment 5 is the method any one of embodiments 1-4, wherein the background audio data comprises encoded musical notes.

Embodiment 6 is the method any one of embodiments 1-5, wherein the generating a mixed audio stream comprises quantizing the audio data in time, pitch, or both.

Embodiment 7 is the method any one of embodiments 1-6, wherein receiving the user interface presentation data comprises receiving user interface presentation data generated by a touch sensitive display, wherein each of a plurality of regions of the touch sensitive display correspond to different audio tones.

Embodiment 8 is the method any one of embodiments 1-7 further comprising:
determining, based at least in part on the user interface presentation data, at least one attribute of at least one of the one or more audio tones to be included in the mixed audio stream; and
generating audio data comprising at least one audio tone with the at least one attribute.

Embodiment 9 is the method of embodiment 8 wherein determining at least one attribute comprises:
determining coordinates associated with the user interface presentation data;
determining, based at least in part on the coordinates, at least one value for the at least one attribute; and
generating audio data comprising at least one audio tone containing the at least one attribute of the at least one value.

Embodiment 10 is the method any one of embodiments 1-9, wherein generating the mixed audio stream comprises continually looping the background audio data representing the one or more audio tones with newly received audio signals from other client devices.

Embodiment 11 is the method any one of embodiments 1-10 further comprising:
receiving, from a second client on a second user device that has joined the audio conversation space, user interface presentation data of the second user device;
generating space data corresponding to the user interface presentation data received at the second user device; and
transmitting the space data to at least one client that has joined the audio conversation space.

Embodiment 12 is the method any one of embodiments 1-11 further comprising:
determining a first location of a first user input and a second location of a second user input;
determining , a duration between the first user input and the second user input;
determining, using the first location, the second location and the duration, a rate of change between the first location and the second location; and
wherein the background audio data is generated, at least in part, using the rate of change.

Embodiment 13 is the method any one of embodiments 1-13 wherein generating background audio data further comprises translating at least one of the one or more audio tones to a textual representations.

Embodiment 14 is the method of embodiment 13 wherein the textual representation is a letter.

Embodiment 15 is the method any one of embodiments 1-14 further comprising:
mapping a first tone of the one or more audio tones to a first fragment of audio data;
mapping a second tone of the one or more audio tones to a second fragment of audio data; and
generating from at least the first fragment of audio data and the second fragment of audio data, an audio file.

Embodiment 16 is a system comprising one or more computers and one or more storage devices storing instructions that are operable, when executed by the one or more computers, to cause the one or more computers to perform the method of any one of embodiments 1-15.

Embodiment 17 is a computer program carrier encoded with a computer program, the program comprising instructions that are operable, when executed by data processing apparatus, to cause the data processing apparatus to perform the method of any one of embodiments 1-15.

Embodiment 18 is the computer program carrier of embodiment 17 wherein the computer program carrier is a non-transitory computer storage medium or a propagated signal.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving, from a first client on a first user device that has joined an audio conversation space of a social messaging platform, user interface presentation data that represents one or more audio tones of background audio for the audio conversation space;
generating, from the user interface presentation, background audio data representing the one or more audio tones of background audio for the audio conversation space;
receiving, from one or more clients, conversation audio data;
generating a mixed audio stream comprising the conversation audio data received from the one or more clients and one or more other audio signals generated from the background audio data representing the background audio for the audio conversation space; and
presenting the mixed audio stream to one or more other client devices that have joined the audio conversation space.

2. The method of claim 1, wherein the background audio data is generated from the user interface presentation data by the client device.

3. The method of claim 1, wherein the background audio data is generated from the user interface presentation data by the social messaging platform.

4. The method of claim 1, wherein the conversation audio data is data generated from one or more microphones of the first user device and the background audio data is not generated from one or more microphones of the first user device.

5. The method of claim 1, wherein the background audio data comprises encoded musical notes.

6. The method of claim 1, wherein the generating a mixed audio stream comprises quantizing the audio data in time, pitch, or both.

7. The method of claim 1, wherein receiving the user interface presentation data comprises receiving user interface presentation data generated by a touch sensitive display, wherein each of a plurality of regions of the touch sensitive display correspond to different audio tones.

8. The method of claim 1 further comprising:
determining, based at least in part on the user interface presentation data, at least one attribute of at least one of the one or more audio tones to be included in the mixed audio stream; and
generating audio data comprising at least one audio tone with the at least one attribute.

9. The method of claim 8 wherein determining at least one attribute comprises:
determining coordinates associated with the user interface presentation data;
determining, based at least in part on the coordinates, at least one value for the at least one attribute; and
generating audio data comprising at least one audio tone containing the at least one attribute of the at least one value.

10. The method of claim 1, wherein generating the mixed audio stream comprises continually looping the background audio data representing the one or more audio tones with newly received audio signals from other client devices.

11. The method of claim 1 further comprising:
receiving, from a second client on a second user device that has joined the audio conversation space, user interface presentation data of the second user device;
generating space data corresponding to the user interface presentation data received at the second user device; and
transmitting the space data to at least one client that has joined the audio conversation space.

12. The method of claim 1 further comprising:
determining a first location of a first user input and a second location of a second user input;
determining , a duration between the first user input and the second user input;
determining, using the first location, the second location and the duration, a rate of change between the first location and the second location; and
wherein the background audio data is generated, at least in part, using the rate of change.

13. The method of claim 1 wherein generating background audio data further comprises translating at least one of the one or more audio tones to a textual representations.

14. The method of claim 13 wherein the textual representation is a letter.

15. The method of claim 1 further comprising:
mapping a first tone of the one or more audio tones to a first fragment of audio data;
mapping a second tone of the one or more audio tones to a second fragment of audio data; and
generating from at least the first fragment of audio data and the second fragment of audio data, an audio file.

16. A system comprising one or more computers and one or more storage devices storing instructions that when executed by the one or more computers cause the one or more computers to perform operations comprising:
receiving, from a first client on a first user device that has joined an audio conversation space of a social messaging platform, user interface presentation data that represents one or more audio tones of background audio for the audio conversation space;
generating, from the user interface presentation data, background audio data representing the one or more audio tones of background audio for the audio conversation space;
receiving, from one or more clients, conversation audio data;
generating a mixed audio stream comprising the conversation audio data received from the one or more clients and one or more other audio signals generated from the background audio data representing the background audio for the audio conversation space; and
presenting the mixed audio stream to one or more other client devices that have joined the audio conversation space.

17. The system of claim 16, the operations further comprising:
determining, by the first client and based on the user input, at least one attribute of at least one of the one or more audio tones to be included in the mixed audio stream; and
generating, at the first client, audio data comprising at least one audio tone with the at least one attribute.

18. The system of claim 17 wherein determining at least one attribute comprises:
determining, at the first client, coordinates associated with the user input;
determining, at the first client and from the coordinates, at least one value for the at least one attribute; and
generating, at the first client, audio data comprising at least one audio tone containing the at least one attribute of the at least one value.

19. The system of claim 16, the operations further comprising:
receiving, at a second client on a second user device that has joined the audio conversation space, user input on a user interface of the second user device;
generating space data corresponding to the user input received at the second user device; and
transmitting the space data to at least one client that has joined the audio conversation space.

20. One or more non-transitory computer-readable storage media storing instructions that when executed by one or more computers cause the one or more computers to perform operations comprising:
receiving, from a first client on a first user device that has joined an audio conversation space of a social messaging platform, user interface presentation data that represents one or more audio tones of background audio for the audio conversation space;
generating, from the user interface presentation data, background audio data representing the one or more audio tones of background audio for the audio conversation space;
receiving, from one or more clients, conversation audio data;
generating a mixed audio stream comprising the conversation audio data received from the one or more clients and one or more other audio signals generated from the background audio data representing the background audio for the audio conversation space; and
presenting the mixed audio stream to one or more other client devices that have joined the audio conversation space.
